(19) United States
(12) Patent Application Publication
(10) Pub. No.: US 2013/0307826 A1
(43) Pub. Date: Nov. 21, 2013

(54) TOUCH PANEL AND TOUCH-DISPLAY PANEL USING THE SAME

(71) Applicant: HengHao Technology Co. LTD, (US)

(72) Inventors: Kuan-Yen MA, Pingzhen City (TW); Chien-Wen LAI, New Taipei City (TW)

(73) Assignee: HengHao Technology Co. LTD, Pingjhen City (TW)

(21) Appl. No.: 13/886,879

(22) Filed: May 3, 2013

Related U.S. Application Data
(60) Provisional application No. 61/642,505, filed on May 4, 2012.

(51) Int. Cl. G06F 3/042

(52) U.S. Cl. CPC G06F 3/0428
USPC 345/175

(57) ABSTRACT

A touch panel and a touch-display panel using the same are provided. The touch panel comprises a substrate, a light-shielding layer, an optical layer and a touch sensing layer. The substrate has a first surface and a second surface opposite the first surface. The light-shielding layer is projectedly disposed in an edge area on the first surface of the substrate. The optical layer covers at least one of the first surface and the second surface of the substrate and the light-shielding layer. The refractive index of the optical layer is greater than 1.5. The touch sensing layer is formed on the optical layer.

This application claims the benefit of U.S. provisional application Ser. No. 61/642,505, filed May 4, 2012, the subject matter of which is incorporated herein by reference, and claims the benefit of Taiwan application Serial No. 102208223, filed May 3, 2013, the subject matter of which is incorporated herein by reference.

### BACKGROUND OF THE INVENTION

1. Field of the Invention

The invention relates in general to a touch panel and a touch-display panel using the same, and more particularly to a touch panel having an optical layer and a touch-display panel using the same.

2. Description of the Related Art

The conventional touch panel comprises a substrate and a plurality of touch-sensing units formed on the substrate for sensing a touch indication. A gap is formed between the touch-sensing units. Since the boundaries of touch-sensing units can be easily recognized from the appearance of the touch-sensing units of the touch panel, the display quality is thus negatively affected.

### SUMMARY OF THE INVENTION

The invention is directed to a touch panel and a touch-display panel using the same. Since the boundaries of the sensing units can be easily recognized from the appearance of the touch-sensing units of the touch panel, negative affection to the display quality is avoided.

According to one embodiment of the present invention, a touch panel is provided. The touch panel comprises a substrate, a light-shielding layer, a first optical layer and a touch sensing layer. The substrate has a first surface. The light-shielding layer is projectedly disposed in an edge area on the first surface of the substrate. The first optical layer covers at least one of the first surface and the second surface of the substrate and the light-shielding layer. The refractive index of the first optical layer is greater than 1.5. The touch sensing layer is formed on the first optical layer.

According to another embodiment of the present invention, a touch-display device is provided. The touch-display device comprises a touch panel and a display panel. The touch panel comprises a substrate, a light-shielding layer, a first optical layer and a touch sensing layer. The substrate has a first surface. The light-shielding layer is projectedly disposed in an edge area on the first surface of the substrate. The first optical layer covers at least one of the first surface and the second surface of the substrate and the light-shielding layer. The refractive index of the first optical layer is greater than 1.5. The touch sensing layer is formed on the first optical layer. The display panel is disposed in correspondence to the touch panel.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view of a touch panel according to an embodiment of the present invention;

FIG. 2 is a partial enlargement of a region 2′ of FIG. 1;

FIG. 3 is a cross-sectional view of a touch panel according to another embodiment of the present invention;

FIG. 4 is a cross-sectional view of a touch panel according to another embodiment of the present invention;

FIG. 5 is a cross-sectional view of a touch-display device according to an embodiment of the present invention.

### DETAILED DESCRIPTION OF THE INVENTION

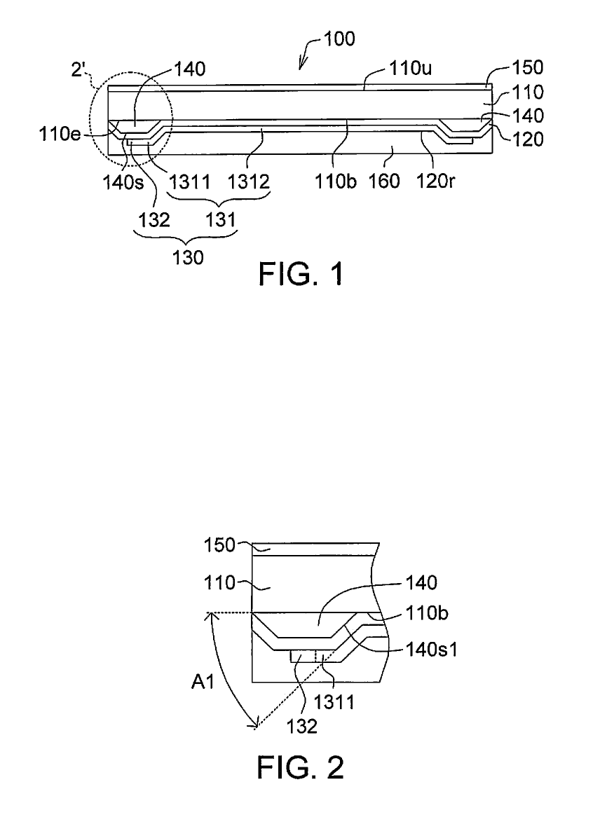

Referring to FIG. 1, a cross-sectional view of a touch panel according to an embodiment of the present invention is shown. The touch panel 100 comprises a substrate 110, a first optical layer 120, a touch sensing layer 130, a light-shielding layer 140, a second optical layer 150 and a covering layer 160.

The touch panel 100 is such as a resistive touch panel, a capacitive touch panel, a projected capacitive touch panel (PCT), an acoustic wave touch panel, an optical touch panel, infrared touch panel or an electromagnetic touch panel.

The substrate 110 has a first surface 110b and a second surface 110u opposite to the first surface 110b. The substrate 110 is a transparent substrate formed by an insulating material with high transmittance such as glass, polycarbonate (PC), polythylene terephthalate (PET), polymethylmethacrylate (PMMA) or cyclic olefin copolymer.

The first optical layer 120 can directly or indirectly cover the first surface 110b and the light-shielding layer 140 of the substrate 110. The present embodiment, the first optical layer 120 directly covers the first surface 110b of the substrate 110. Since the refractive index of the first optical layer 120 is greater than 1.5, the boundaries of the sensing units will not be easily recognized from the appearance of the touch sensing layer 130.

The first optical layer 120 is formed along the first surface 110b of the substrate 110 and the outer surface 140s of the light-shielding layer 140. The first optical layer 120 complies with the lineament of the outer surface 140s of the light-shielding layer 140 and that of the first surface 110b of the substrate 110 to form a depressed portion 120r. Since the first optical layer 120 is formed conformably, the thickness of the first optical layer 120 is consistent in each part.

The first optical layer 120 is formed by a transparent organic material or a transparent inorganic material. The transparent organic material is such as photo-resist, and the transparent inorganic material is such as silicon oxide or metal oxide. The first optical layer 120 can be formed by way of physical vapor deposition (PVD), chemical vapor deposition (CVD), coating, printing, spinning or spraying.

The touch sensing layer 130 is formed on the first optical layer 120, and complies with the lineament of the first optical layer 120 to be formed in the depressed portion 120r.

The touch sensing layer 130 comprises a touch-sensing portion 131 and a plurality of signal traces 132. The touch-sensing portion 131 can sense a touch signal of finger or touch pen. A segment 1311 of the touch-sensing portion 131 is formed in correspondence to an area of the light-shielding layer 140. The light-shielding layer 140 is formed in an edge area 110e on the first surface 110b of the substrate 110, such that the segment 1311 of the touch-sensing portion 131 is correspondingly formed in the edge area 110e on the first surface 110b to provide an edge touch function of the touch panel 100. Another segment 1312 of the touch-sensing portion 131 is formed in an area surrounded by the light-shielding layer 140.

The signal traces 132 are formed in correspondence to an area of the light-shielding layer 140, and are connected to the touch-sensing portion 131 to transmit the signals between the touch-sensing portion 131 and a printed circuit board (not illustrated).

The structure of the touch sensing layer 130 varies with the types of the touch panel 100. Let the capacitive touch panel be taken for example. The touch-sensing portion 131 comprises a plurality of first sensing lines (not illustrated), a plurality of second sensing lines (not illustrated) and an insulating layer (not illustrated). The insulating layer is formed between the first sensing lines and the second sensing lines so as to electrically isolate the first sensing line from the second sensing line. Each first sensing line is formed on the substrate along the first direction, and comprises a plurality of first sensing units and a plurality of first wires. The first wires electrically connect two adjacent first sensing units. Similarly, each second sensing line is formed on the substrate along the second direction, and comprises a plurality of second sensing units and a plurality of second wires. The second wires electrically connect two adjacent second sensing units.

The shapes of the first sensing unit and the second sensing unit are shaped into prismatic, triangular or rectangular. A gap is formed between the boundaries of two adjacent first and second sensing units to avoid the two adjacent sensing units being electrically connected to each other. Since the refractive index of the first optical layer 120 is greater than 1.5, the boundaries of the sensing units will not be easily recognized from the appearance of the touch sensing layer 130.

The first sensing unit and the second sensing unit can be formed by a transparent conductive material, such as transparent conductive oxide (TCO), or a transparent organic conductive material. The transparent conductive material is such as indium tin oxide (ITO) or indium zinc oxide (IZO). The transparent organic conductive material is such as poly(3,4-ethylenedioxythiophene) (PEDOT). The first wires and the second wires are formed by such as metal or a transparent conductive material. The metal can be selected from titanium, aluminum, molybdenum, copper, silver and a group composed thereof. Besides, the first wires and the second wires can be a uni- or multi-layered structure.

The light-shielding layer 140 is projectedly disposed in an edge area 110e on the first surface 110b of the substrate 110. The light-shielding layer 140 is such as black matrix. Besides, the color of the light-shielding layer 140 is such as black, blue, green or red. The color of the light-shielding layer 140 is not restricted by the embodiment of the present invention, and any color would do as long as the light-shielding layer 140 can shield the light.

Referring to FIG. 2, a partial enlargement of a region 2′ of FIG. 1 is shown. An inner lateral surface 140s1 of the light-shielding layer 140 of the present example is an inclined surface. In comparison to the vertical inner lateral surface, the touch sensing layer 130 formed on the inner lateral surface 140s1 is prevent from being broken during the formation of the touch sensing layer 130. That is, through the inclined surface (the inner lateral surface 140s1), the touch sensing layer 130 formed on the inner lateral surface 140s1 can maintain a continuous structure. In an example, an included angle A1 formed between the inner lateral surface 140s1 and the first surface 110b of the substrate 110 ranges between 1 and 89 degrees. If the included angle A1 is less than 50 degrees, the first optical layer 120 and/or the touch sensing layer 130 formed on the inner lateral surface 140s1 will be free of breakage which would occur when the slope of the inner lateral surface 140s1 is too large.

The second optical layer 150 is formed on the second surface 110u of the substrate 110 to provide a finger-pollution resistant function. The second optical layer is formed by such as a fluorine-based compound or a silicon compound. In another example, the second optical layer 150 can be omitted.

The covering layer 160 is an overcoating layer, which covers the touch sensing layer 130 to protect the touch sensing layer 130. The covering layer 160 is formed by such as a silicon oxide. In another embodiment, the covering layer 160 can be omitted.

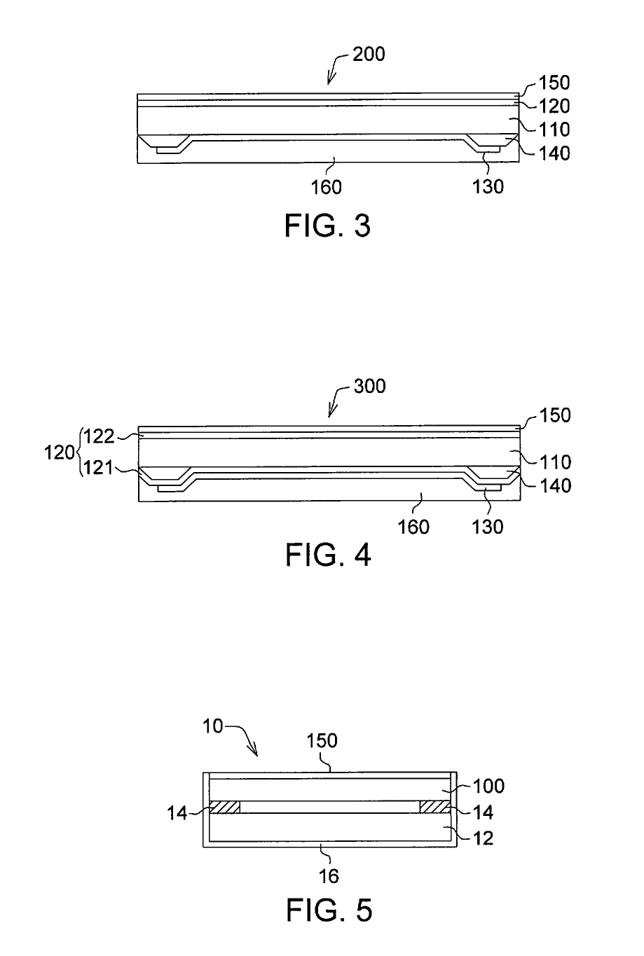

Referring to FIG. 3, a cross-sectional view of a touch panel according to another embodiment of the present invention is shown. The touch panel 200 comprises a substrate 110, a first optical layer 120, a touch sensing layer 130, a light-shielding layer 140, a second optical layer 150 and a covering layer 160.

The present embodiment, the first optical layer 120 covers the second surface 110u of the substrate 110. Since the refractive index of the first optical layer 120 is greater than 1.5, the boundaries of the sensing units will not be easily recognized from the appearance of the touch sensing layer 130 of the touch panel 200.

Referring to FIG. 4, a cross-sectional view of a touch panel according to another embodiment of the present invention is shown, The touch panel 300 comprises a substrate 110, a first optical layer 220, a touch sensing layer 130, a light-shielding layer 140, a second optical layer 150 and a covering layer 160.

In the present embodiment, the first optical layer 220 comprises a first sub-optical layer 121 and a second sub-optical layer 122. The first sub-optical layer 121 covers the first surface 110b and the light-shielding layer 140 of the substrate 110. The second sub-optical layer 122 covers the second surface 110u of the substrate 110. Since the refractive index of the first optical layer 220 is greater than 1.5, the boundaries of the sensing units will not be easily recognized from the appearance of the touch sensing layer 130 of the touch panel 300. Besides, the first sub-optical layer 121 and the second sub-optical layer 122 can be formed by materials similar to that of the first optical layer 120, and the similarities are not repeated here.

Referring to FIG. 5, a cross-sectional view of a touch-display device according to an embodiment of the present invention is shown. The touch-display device 10 comprises a display module 12, an adhesion layer 14, an outer frame 16 and at least one of the touch panels 100, 200 and 300. In the present example, the touch-display device 10 comprises the touch panel 100.

The display module 12 is disposed in correspondence to the touch panel 100. The display module 12 is such as an electrophoretic display, a cholesteric liquid crystal display, a liquid crystal display, a bistable display, a multi-stable display, an organic light-emitting diode (OLED) display, a light-emitting diode (LED) display or a display module having other types of display panel. When the display panel is non-self-luminous type, the display module 12 further comprises a backlight module for providing light to the display panel.

The adhesion layer 14 is such as a double-sided adhesive capable of adhering the touch panel 100 and the display module 12. The outer frame 16 can accommodate the display module 12 and the touch panel 100 to protect the display module 12 and the touch panel 100.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a substrate having a first surface and a second surface opposite the first surface;
a light-shielding layer projectedly disposed in an edge area on the first surface of the substrate;
a first optical layer covering at least one of the first surface and the second surface of the substrate and the light-shielding layer, wherein a refractive index of the first optical layer is greater than 1.5; and
a touch sensing layer formed on the first optical layer.

2. The touch panel according to claim 1, wherein the first optical layer complies with the first surface of the substrate and the outer surface of the light-shielding layer to form a depressed portion in which the touch sensing layer is formed.

3. The touch panel according to claim 1, wherein the first optical layer complies with a lineament of the outer surface of the light-shielding layer and that of the first surface of the substrate.

4. The touch panel according to claim 1, wherein the first optical layer comprises:
a first sub-optical layer covering the first surface of the substrate and the light-shielding layer; and
a second sub-optical layer covering the second surface of the substrate.

5. The touch panel according to claim 1, wherein the light-shielding layer has an inner lateral surface of the light-shielding layer is an inclined surface.

6. The touch panel according to claim 5, wherein an included angle between the inner lateral surface of the light-shielding layer and the first surface of the substrate ranges between 1 and 89 degrees.

7. The touch panel according to claim 5, wherein an included angle formed between the inner lateral surface of the light-shielding layer and the first surface of the substrate is less than 50 degrees.

8. The touch panel according to claim 1, further comprising:
a covering layer covering the touch sensing layer.

9. The touch panel according to claim 1, further comprising:
a second optical layer formed on the second surface of the substrate.

10. The touch panel according to claim 9, wherein the second optical layer is a finger-pollution resistant layer.

11. The touch panel according to claim 1, wherein the touch sensing layer comprises:
a touch-sensing portion, wherein a segment of the touch-sensing portion is formed in correspondence to an area of the light-shielding layer; and
a plurality of signal traces formed in correspondence to an area of the light-shielding layer and connected to the touch-sensing portion to transmit the signals of the touch-sensing portion.

12. A touch-display device, comprising:
a touch panel, comprising:
a substrate having a first surface and a second surface opposite the first surface;
a light-shielding layer projectedly disposed in an edge area on the first surface of the substrate;
a first optical layer covering at least one of the first surface and the second surface of the substrate and the light-shielding layer, wherein a refractive index of the first optical layer is greater than 1.5; and
a touch sensing layer formed on the first optical layer; and
a display module disposed in correspondence to the touch panel.

13. The touch-display device according to claim 12, wherein the first optical layer complies with the first surface of the substrate and the outer surface of the light-shielding layer to form a depressed portion in which the touch sensing layer is formed.

14. The touch-display device according to claim 12, wherein the first optical layer complies with a lineament of an outer surface of the light-shielding layer and that of the first surface of the substrate.

15. The touch-display device according to claim 12, wherein the first optical layer comprises:
a first sub-optical layer covering the first surface of the substrate and the light-shielding layer; and
a second sub-optical layer covering the second surface of the substrate.

16. The touch-display device according to claim 12, wherein the light-shielding layer has an inner lateral surface of the light-shielding layer is an inclined surface.

17. The touch-display device according to claim 16, wherein an included angle between the inner lateral surface and the first surface of the substrate ranges between 1 and 89 degrees.

18. The touch-display device according to claim 17, wherein an included angle between the inner lateral surface and the first surface of the substrate is less than 50 degrees.

19. The touch-display device according to claim 12, wherein the touch panel further comprises:
a covering layer covering the touch sensing layer.

20. The touch-display device according to claim 12, wherein the touch panel further comprises:
a second optical layer formed on the second surface of the substrate.

21. The touch-display device according to claim 20, wherein the second optical layer is a finger-pollution resistant layer.

22. The touch-display device according to claim 12, wherein the touch sensing layer comprises:
a touch-sensing portion, wherein a segment of the touch-sensing portion is formed in correspondence to an area of the light-shielding layer; and
a plurality of signal traces formed in correspondence to an area of the light-shielding layer and connected to the touch-sensing portion to transmit a signal of the touch-sensing portion.
